(19) United States
(12) Patent Application Publication
(10) Pub. No.: US 2025/0247434 A1
(43) Pub. Date: Jul. 31, 2025

(54) NETWORK SECURITY POLICY GENERATION AND DISTRIBUTION

(71) Applicant: Salesforce, Inc., San Francisco, CA (US)

(72) Inventor: Kaushal BANSAL, Pleasanton, CA (US)

(21) Appl. No.: 18/426,650

(22) Filed: Jan. 30, 2024

(51) Int. Cl. H04L 9/40

(52) U.S. Cl. CPC H04L 63/205

(57) ABSTRACT

Systems, devices, and techniques are disclosed for network security policy generation and distribution. A security policy written using a Domain Specific Language (DSL) for network security may be received. The security policy may be associated with a service owner and a control plane. A representation of the security policy may be generated from the security policy. A configuration bundle of the service owner may be updated with the representation of the security policy. The security policy may be determined to be approved. A rule set may be generated from the representation of the security policy. A differential between the rule set and a current rule set may be determined. A security component associated with the control plane based on the differential may be configured.

### BACKGROUND

An intent based domain specific language (DSL) may be used to define security policies for an application, such as a Software-as-a-Service (SaaS) application, running on a cloud computing server system. The DSL may be designed for use by developers of the application, who may not have detailed knowledge of network security. A service of the cloud computing server system may interpret policies defined using DSL to generate cloud native enforcement artifacts, which may be machine-readable files that specify network security policies in a manner that is useable by the cloud computing server system on which the policies are being enforced. All of the developers of applications running on the cloud computing server system may use the DSL to define and update security policies for their applications. This may result in a large number of different, changing, security policies that may need to be reconciled in order to implement an overall security policy on the cloud computing server system.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for network security policy generation and distribution according to an implementation of the disclosed subject matter.

FIG. 2 shows an example arrangement suitable for network security policy generation and distribution according to an implementation of the disclosed subject matter.

FIG. 3 shows an example arrangement suitable for network security policy generation and distribution according to an implementation of the disclosed subject matter.

FIG. 4 shows an example procedure suitable for network security policy generation and distribution according to an implementation of the disclosed subject matter.

FIG. 5 shows an example procedure suitable for network security policy generation and distribution according to an implementation of the disclosed subject matter.

FIG. 6 shows a computer according to an implementation of the disclosed subject matter.

FIG. 7 shows a network configuration according to an implementation of the disclosed subject matter.

### DETAILED DESCRIPTION

Techniques disclosed herein enable network security policy generation and distribution, which may allow for the implementation of network security policies for multiple applications on a cloud computing server system that are written using a Domain Specific Language (DSL) and implemented with cloud native enforcement artifacts. Files including code written using a Domain Specific Language (DSL) for network security may be received. Cloud native enforcement artifacts may be generated from the code written using DSL the files. A security configuration may be generated based on the cloud native enforcement artifacts and a baseline security policies. The security configuration may be distributed to two or more components of a cloud computing server system.

Files including code written using a Domain Specific Language (DSL) for network security may be received. A DSL may be used by a developer of an application, such as a Software-as-a-Service (SaaS) application, to write code that defines the network security policies that will be needed by the application. The DSL may be an intent-based language. The policies described using a DSL may include, for example, the types of network services on a cloud computing server system the application will need access to in order to run properly on the cloud computing server system. For example, a SaaS application running on a cloud computing server system may need to be able to communicate with other SaaS applications running on that cloud computing server system. The code written in DSL for such a SaaS application may specify the need for this type of network access, for example, identifying the other SaaS applications that will be communicated with. The code written in DSL for an application may be stored in file which may be received at the cloud computing server system on which the application is installed, for example, along with the installation of the application. All of the developers who have applications running on the cloud computing server system may write code using the DSL to define network security policies for their applications and may send files with this DSL code to a security policy controller of the cloud computing server system.

Allowing developers to specify their own network security policies using a DSL may provide separation of concerns for developers and for parties responsible for the security of the cloud computing server system whose primary responsibility may be to ensure that their infrastructure on the cloud computing server system is compliant with any required security postures, after which they may help enable developers, or service owners, to have agility in the changing of the network security policies for their applications.

The security configuration may include a repeatable default posture, which may include defaults set by a party that controls the cloud computing server system. As new environments are built out on the cloud computing server system, for example, to host applications and services from developers, or service owners, the repeatable default posture may be a default security posture for network segmentation and that may be repeatable manner. The default security posture may be implemented using baseline security policies.

Parts of the security configuration that are from the repeatable default posture may be overridden by the network security policies specified by developers using the DSL. Guardrail policies may ensure that the network security policies specified by developers do not break the required security posture of the cloud computing server system. For example, only certain kinds of ports may be allowed, or only certain kinds of network segments may be allowed to talk to each other and not vice versa. A network security policy specified by a developer using a DSL that violates a guardrail policy may not be integrated into the security configuration for the cloud computing server system.

The default posture may enable certain types of connectivity within the cloud computing server system, while service owners would then need to be configure connectivity for their applications and services, for example, using the DSL.

The security configuration may be based on a hierarchical model. In the hierarchical mode, the guardrail policies from the default posture may be at the top of the hierarchy, as the guardrail policies may not be overridden. Security policies configured by the service owners for their applications may be below the guardrail policies, as these security policies may not override the guardrail policies. Overridable policies from the default posture may be at the bottom of the hierarchy, as they may be overridden by the security policies specified by the service owner.

An API based interface may allow, for example, network security engineers responsible for the cloud computing server system, to configure the baseline security policies for the default security posture for the security configuration of the cloud computing server system. This may include configuring both the guardrail policies and the overridable policies. The API may be used configure and modify the default posture at any time. The service owners whose applications and services run on the cloud computing server system may have no ability to configure or modify the default posture.

A configuration realization control plane may be a highly scalable, high throughput intelligent control plane which may continuously monitor changes service owners make to their own security configurations, which may be represented as immutable configuration bundles. The configuration realization control plane may monitor immutable configuration bundles generated by the service owners and may then invoke various control owner APIs to consolidate these configuration bundles in a single Bill of Material. The control owners may be, for example, firewalls, load balancers, routers, application firewalls, IAM policy controllers, DNS servers, and egress controls of the cloud computing server system. The control owners may provide security and availability guarantee for the service owners.

Cloud native enforcement artifacts may be generated from the code written using DSL the files. When a service owner adds or changes a security policy using the DSL, the security policy may need to be converted from the DSL into a cloud native enforcement artifact, or other suitable format, for integration into the security configuration. A policy generator service may use the code written in DSL in the received files to generate cloud native enforcement artifacts to implement the security policies defined using the DSL in the files. Because the DSL is intent based, the code written using DSL may not be directly implemented as network security policies by the cloud computing server system. The code written using DSL may, for example, not directly specify which ports should be open and which should be closed, what protocols should be used by open ports, and what services should be exposed through open ports. The cloud computing server system may run a policy generator service that may interpret policies defined using DSL to generate cloud native enforcement artifacts that may include machine-implementable network security policies. The cloud native enforcement artifacts generated from a file that includes DSL defining network security policies for an application may be stored on the cloud computing server system on which that application will run, and may be generated in a format suitable for that cloud computing server system. The cloud native enforcement artifacts may define network security policies on an implementation-level, including specifying which ports should be opened and closed and when, what network communication protocols are used on which ports, and what services will be exposed through open ports. Cloud native enforcement artifacts generated by the policy generator from a service owner's DSL file may be added to that service owner's configuration bundle.

Each security policy specified by a service owner, including newly specified security policies and changes to already specified security policies, may be subject to an approval process before being included in the security configuration for the cloud computing server system. If a security policy is auto-approved then it may be merged into the security configuration without any conflict. If the security policy is not auto-approved, approval notifications may be generated and presented to the control owner to review the changes. If the security policy is disapproved by the control owner, notifications may be sent back to the service owner to remove the disapproved security policy.

When a service owner makes a change to their security policies, for example, changing a current security policy or adding a new security policy, and the security policy is approved, it may be included in the security configuration for the cloud computing server system and distributed to the appropriate components of the cloud computing serer system. For example, if the security policy is related to firewalls of the cloud computing server system, the configuration realization control plane may attempt to invoke APIs for a firewall control plane in order to forward the security configuration.

The configuration realization control plane may be connected to an artifactory repository which may store the cloud native enforcement artifacts generated based on the DSL files received from the service owners. The cloud native enforcement artifacts for a specific service owner may be the configuration bundle for that service owner. This configuration realization control plane may have control of control owner agents, with each control owner agent being associated with specific components of the cloud computing server system. The control owner agents, which may be running processes, may parse the specific parts the configuration bundles in the artifactory that are related to the components of the cloud computing server system associated with that control owner agent and may provide the necessary integration with the required control plane to implement the security policies in the configuration bundle. For example, for a firewall-specific control, an control owner agent that is a firewall agent running as part of the configuration realization control plane, and may isolate firewall configurations from the configuration bundles in the antifactory and then invoke the appropriate APIs on the firewall control plane to cause provisioning agents to implement the security policies from the configuration bundles on the firewalls of the cloud computing server system. The control owner agents may also be connected to an approval system to obtain approval of the security policies in the configuration bundles. The use of the control owner agents as part of the configuration realization control plane may allow for continuous integration of the security policies in the security configuration of the cloud computing server system with the components of the cloud computing server system responsible for the implementation of the security configuration. The control owner agents may continuously monitor the cloud native enforcement artifacts of the configuration bundles for changes in security policies and implement any detected changes in the security policies on the appropriate components of the cloud computing server system.

The approval system may allow for the continuous integration process to be automated. The approval system may be able to auto-approve changes to security policies and to send changes that are not auto-approved to be manually reviewed and approved by the control owner.

The approval system may include a registration system for security policies that can be automatically approved. The registration system may allow the control owner to register a set of security policies which may be auto-approved for all applications and services running on the cloud computing server system and a set of services or a specific service for invoking an API call on the configuration realization control plane.

For example, inter-network segment configuration policies may be automatically approved by the approval system. A service owner may specify a security policy that allows a web service running a processing network segment of the cloud computing server system to connect to an RDS database running in a restricted network segment of the cloud computing server system. The firewall control plane may expose an API which may be used to allow connectivity across different network segments. A firewall control plane user may register this specific API with the approval system with the condition that all service owners are allowed to use the API. The service owner may add a new security policy that would allow connectivity between the web service running in the processing network segment and the RDS database running in the restricted network segment. This security policy may be interpreted, for example, to generate a cloud native enforcement artifact for the security policy and added as part of the service owner's configuration bundle in the artifactory repository. A firewall agent running as part of the configuration realization control plane may detect the new security policy that allows connectivity between the web service and the RDS database in the newest version of the service owner's configuration bundle. The firewall agent may check the approval system to determine if the service owner is allowed to add this security policy to the security configuration of the cloud computing server system. The approval system may determine that the service owner is allowed to add this security policy based on the security policy being registered for auto-approval with the approval system. The approval system may indicate to the firewall agent that the security policy is auto-approved. The firewall agent may then invoke the appropriate exposed APIs of the firewall control plane to configure the firewalls of the cloud computing server system to implement the security policy, allowing for the service owner's web service in the processing network segment to connect to the RDS database in the restricted network segment.

Security policies that are not auto-approved may be sent by the approval system for manual review. The manual review may be performed by, for example, a party that is one of the control owners of the cloud computing server system. For example, a security policy that allows connectivity that goes through a cross-region over the internet may not be auto-approved, and may require an explicit approval before the security policy can be merged into the security configuration for the cloud computing server system.

For example, a service owner may add a security policy which may allow connectivity between a web service running on the cloud computing server system and another service running in a different region from the web service, requiring the connection to be made through the internet. This security policy may be interpreted, for example, to generate a cloud native enforcement artifact for the security policy and added as part of the service owner's configuration bundle in the artifactory repository.

The firewall agent running as part of the configuration realization control plane may detect the new security policy that allows connectivity between the web service and the service in a different region in the newest version of the service owner's configuration bundle. The firewall agent may check the approval system to determine if the service owner is allowed to add this security policy to the security configuration of the cloud computing server system. The approval system may determine that the security policy is not registered for auto-approval with the approval system. The approval system may generate a request for approval of the configuration bundle with the new security policy. The request may be marked as a pending request and the approval system may assign an expiration time to the request so that the request is time bounded. The approval system may send a notification to the firewall agent regarding the generation of the request. The approval system may send the request to a specific control owner of the cloud computing server system. The specific control owner to which a request is sent may be based on configuration of the approval system. For example, each control owner agent that runs in the configuration realization control plane may be have an associated specific control owner in the approval system. A security policy that needs manual approval may have the request generated by the approval system for that security policy sent to the specific control owner associated with the control owner agent that checked the approval system to determine if the security policy would be auto-approved. The approval system may send a notification to review the request to any suitable party associated with the appropriate control owner in any suitable manner, including through email, direct messaging, or any other suitable form of electronic communication. For example, a request for a firewall policy that needs manual approval may be sent to a network security engineer who is associated with the firewall of the cloud computing server system.

The specific control owner, upon receiving a notification that they have request to review, may either approve or disapprove the request. The party associated with the control owner may, for example, view the request within the approval system, including any suitable information that is part of the request and may input their decision to approve or disapprove the request into the approval system, which may then take appropriate action. For example, if the control owner approves the request in the approval system, the configuration bundle with the new security policy may be merged into the security configuration for the cloud computing server system. The appropriate control owner agent, such as, for example, the firewall agent, may then invoke the appropriate exposed APIs of the appropriate control plane to cause that control plane to configure the appropriate components of the cloud computing server system to implement the security policy, for example, configuring the firewall to allow the service owner's web service to connect with a service in a different region. Alternatively, if the control owner rejects the request, the security policy may not be merged into the security configuration and the service owner may be notified that their security policy was rejected.

The control owner agents running as part of the configuration realization control plane may synchronize the configuration bundles of the service owners with the security configuration of the cloud computing server system. There may be a feedback loop between the two systems. A tracing ID may also be used which may be passed from the beginning of the change made by the service owner generated as a part of the continuous integration process. The same notifications may be send using the same tracing ID to allow for tracing back to the original changes made by the service owner to their security policies.

When a change to a security policy made by a service owner is successful, for example, was auto-approved and then successfully merged into the security configuration by the control owner agents in the configuration realization control plane and distributed to the control plane of the appropriate components of the cloud computing server system, the service owner may notified in any suitable manner. For example, the service owner may be notified through any suitable form of electronic communication or may be able to check the status of their security policy change through, for example, any suitable application.

In the case of a change to security policy which fails, for example, is not auto-approved and does not receive manual approval, a notification may be sent to the service owner indicating that the security policy change was not approved. The service owner may then revert the change to their security policies that was not approved to ensure that their security policies remain synchronized with the actual security configuration of the cloud computing server system. The service owner may manually revert the change from their own repository for their application or service on the cloud computing server system. Alternatively, there may be a general purpose sub-system that may listen for failure events apart from the service owner and identify the security policy change in the service owner's repository and send a request to the service owner that the service owner can use to roll back the change. The sub-system may also use back-off algorithm that may auto-merge code in the service owner's repository to revert the security policy change that failed, for example, if the service owner does not do so themselves within a specified time period.

A security configuration may be generated based on the cloud native enforcement artifacts and a baseline security policies. Cloud native enforcement artifacts may be generated based on every file with DSL code received by the security policy controller. The network security policies implemented by the cloud native enforcement artifacts may need to be merged into a security configuration that may be distributed to the various components of the cloud computing server system, such as firewalls, load balancers, routers, IAM policy controllers, DNS servers, and egress controllers. The security configuration may also be based on baseline security policies for the cloud computing server system. The baseline security policies may be network security policies that may have been generated by, for example, a party responsible for the overall security of the cloud computing server system. The baseline security policies may be focused on the overall security of the cloud computing server system and may provide guard rails and policies to prevent zero-day attacks and vulnerabilities. The baseline security policies may protect the infrastructure of the cloud computing server system, ensure that the infrastructure is compliant with different compliance standards, such as, for example, HIPAA, and with security standards, such as, for example, NIST. The baseline security policies may include guardrail policies that may provide guard rails which may not be overridden by any network security policy for any application as defined in the DSL in the files received by the security policy controller. For example, a guardrail policy may block a specific port number on any computing device within the cloud computing server system that has a public IP address and is accessible through the internet. The baseline security policies may include default policies for every new instance deployed on the cloud computing server system that establish a default security posture that may be considered secure by default and may divide the network into different segments and configure default connectivity. The baselines security policies may include overridable policies, which may be default security policies that are allowed to be overridden for the security policies for individual applications.

The security configuration may be generated using continuous integration and distributed using continuous deployment. The cloud computing server system may host any number of applications from any number of developers, all of whom may makes changes to the network security policies for their applications at any time. This may require that changes to the security policies for the applications hosted on the cloud computing server system be continuously integrated into the security configuration, which may then be continuously distributed to the components of the cloud computing server system.

The security configuration may be distributed to two or more components of a cloud computing server system. Control configuration control planes for the various control owners of the cloud computing server system may be used to distribute changes to the security configuration to the appropriate components of the cloud computing server system. For example, a control configuration control plane for the firewall of the cloud computing server system may be utilized to configure firewalls of the cloud computing server system and to support the network segmentation requirement and block embargoed nations through geo-blocking or large scale IP blocking. The firewall of the cloud computing server system may be a logical service that may provide a unified interface to the entirety of the cloud computing server system, where enforcement may occur on various levels of the cloud computing server system and may use various different types of enforcement, such as, for example, host based agents, inline network appliances, and an overlay network appliance at a centralized location. Configuration of the firewall may be represented using lower level constructs, such as a 5-tuple firewall rule, and higher-level constructs such as services and functional domains.

A data model used by the control configuration control plane may be able support a hierarchy so that the security configuration may be partitioned in different blocks, some of which may be overridable and some of which may not be overridable. At the level of data model, the security configuration for the control configuration control plane may be abstracted and human readable and may not be used to actually configure the firewall.

The data model may include logical boundaries between the network domain, compute domain, network segment, and instance in the cloud computing server system. The network domain of the data model may represent the network boundary without a routing requirement. If there are no network controls placed in a network domain, any component within the network domain that has an IP address may talk to any other component within the network domain that has an IP address without sending network traffic through a routing device. The network domain may be a non-overlapping IP space which may be further divided into multiple network segments. The network segments may be represented by a virtual private network in a public cloud computing server system or a flat Level 2 domain in a physical datacenter.

The compute domains may be logical divisions of the cloud computing server system and that may represent the services provided to a service owner of the cloud computing server system. A single compute domain may be entirely contained within a single network domain, though in some cases a compute domain may cross over multiple network domains.

An instance may be self-sufficient to service the service owners in a particular geographic region without having any dependencies. An instance may include multiple network domains which may have non-overlapping IP addresses, or may be connected using a routing device and a network address translation device. Any two network domains that are part of the same instance may not be able to communicate over layer 3 or layer 4. There may be no communication between different instances, for example, due to guardrail policies. Computer domains within a network domain may not be able communicate with each other until there is an explicit security policy added by a service owner to the security configuration of the cloud computing server system that allows for such communication. A network segment within a compute domain may not be able to communicate with any another network segment other until there is an explicit security policy added by a service owner to the security configuration of the cloud computing server system that allows for such communication. A network segment from a given compute domain may not be able to communication with a restricted network segment in another compute domain for example, due to guardrail policies. All services in a given network segment in a given compute domain may be able to communicate with each other by default, as per a default policies set by the control for the cloud computing server system, although a service in a given network segment can revoke the default policy for itself and prevent other services from communicating with it unless permitted to do so by explicit security policy from the service owner.

When merging security policies from the configuration bundles into the security policy for the cloud computing server system, the configuration realization control plane may ensure that service owner security policies do not override or conflict with the security policies in configurations belonging to other service owners or guard rail policies.

After security policies have been merged into the security configuration, the security configuration may then be translated into a general firewall configuration, including the context where the configuration will be applied, such as, for example, a firewall at perimeters of an instance that may be used to enforce various security policies, including embargoes nation policies and some network segmentation policies. Other security policies from the security configuration may be applied within an instance, for example, including security policies with network segmentation rules that may be enforced using a host-based agent, a distributed firewall that may be SDN based, or network appliance. An ordered set of firewall rules that govern the allowance and disallowance of connectivity may be generated from the relevant security policies that have been merged into the security configuration. The ordered set of firewall rules may include, at the top of the order, rules based on the guard rail policies set by the control owner, then rules based on service owner security policies for every relevant service owner, and then rules based on overridable policies set by the control owner.

Once the security configuration is persisted successfully in the system, it may then be further provisioned to various control endpoints in an asynchronous but continuous manner through continuous deployment. The security configuration may be sent to the various control configuration control planes by the appropriate control owner agents of the configuration realization control plane. The control configuration control planes of the cloud computing server system may listen for notifications indicating a security policy change made by any service owner or the control owner that has been merged into the security configuration for the cloud computing server system. The control configuration control planes may then generate the required rule sets by querying the stored security configuration as received from the control owner agents of the configuration realization control plane and building complete rule sets. A rule set generated by a control configuration control plane may be a generic 5-tuple firewall rule with additional metadata for further processing. The control configuration control plane may then schedule the generated rules to be provisioned, adding them to a scheduling queue of a scheduling component of the control configuration control plane.

The scheduling component of the control configuration control plane may pick rules from the scheduling queue and assign them to worker agents. The worker agents may perform a diff operation to identify what rules need to be added, removed or updated in order implement the rule sets assigned to them and ensure that the security policies of the cloud computing server system are brought up-to-date with the security configuration by implementing the rule sets from the queue assigned to the worker agents. The worker agents may then pass the result of the diff operations, including what rules to add, remove, or update, to provisioning agents of the control configuration control plane.

The provisioning agents may generate the configurations specific to the components, including hardware and software, that will be used to enforce the rules, implementing the security policies in the security configuration. For example, if a firewall of a specific type is used by the cloud computing server system, a provisioning agent specific to that type of firewall may generate the configuration for the firewall to implement the rules that need to be enforced by that firewall. If there is no transactional support, the provisioning agent may try to imitate a transactional logic on top of the exposed mechanism of the component that the provisioning agent is meant to configure. Provisioning agents may also use a retry logic with a backoff algorithm, so that a provisioning agent may retry configuring a component in the event of configuration failures a set of number of times before rolling back the component to its last good known configuration and sending a notification, for example, to a party responsible for maintain the component indicating that configuration failed. Each of the control configuration control planes may have its own provisioning agents that may be specific to the components of the cloud computing server system that the control configuration control plane is responsible for configuring.

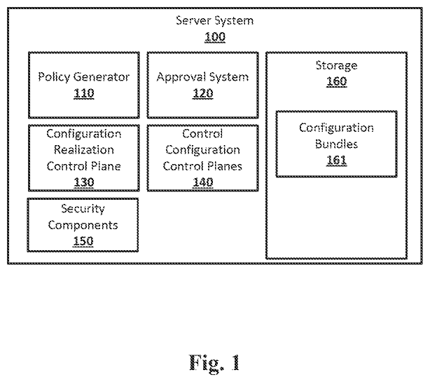

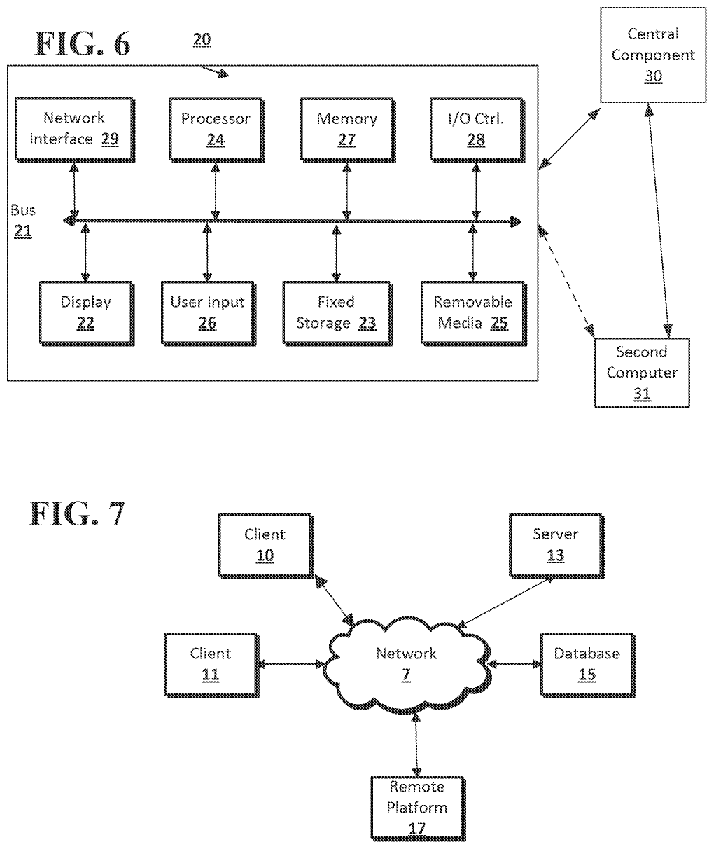

FIG. 1 shows an example system suitable for provisioning and secure access control for storage on public servers according to an implementation of the disclosed subject matter. A server system 100 may include, for example, the computer 20 as described in FIG. 6, or components thereof. The server system 100 may include any number computing devices, each of which may include any suitable combination of central processing units (CPUs), graphical processing units (GPUs), and tensor processing units (TPUs). The server system 100 may be distributed over any geographic area, and may, for example, include geographically disparate computing devices connected through any suitable network connections. The server system 100 may be, or be a part of, a cloud computing server system that may support multi-tenancy. The server system 100 may include a policy generator 110, approval system 120, configuration realization control plane 130, control configuration control planes 140, security components 150, and a storage 160.

The policy generator 110 may be any suitable combination of hardware and software of the server system 100 for generating a representation of security policies as cloud native enforcement artifacts, or other suitable forms, from code written in DSL, a policy domain model from code written in DSL and cloud native enforcement artifacts, and updated cloud native enforcement artifacts from a policy domain model. For example, the policy generator 110 may be a service running on the server system 100, which may be, or be part of, a cloud computing server system, that may generate cloud native enforcement artifacts 163 from a domain specific language file provided by a service owner. The domain specific language file may include code written in a DSL that defines network security policies for an application, such as a SaaS application, that may be run on a cloud computing server system that may include the server system 100. The representation of the security policies, such as the cloud native enforcement artifacts, generated by the policy generator 110 from the domain specific language file may be files used to implement the network security policies defined in the domain specific language file and may be in a format that is suitable for machine-reading and implementation.

The approval system 120 may be any suitable processes and services on the server system 100 that may evaluate security policies provided by service owners and may either auto-approve the security policies or send the policies to the appropriate control owner for manual approval or rejection. The approval system 120 may include a registration system for security policies that can be automatically approved. The registration system may allow control owners to register a set of security policies which may be auto-approved by the approval system 120 for all applications and services running on the cloud computing server system, for example, the server system 100, and a set of services or a specific service for invoking an API call on the configuration realization control plane.

The configuration realization control plane 130 may be any suitable processes and services running on the server system 100 that may implement a highly scalable, high throughput intelligent control plane which may continuously monitor changes service owners make to their own security configurations, which may be represented as immutable configuration bundles, for example, configuration bundles 161 stored in the storage 160. The configuration realization control plane 130 may include control owner agents that may monitor immutable configuration bundles generated by the service owners and may then invoke various control owner APIs to consolidate these configuration bundles in a single Bill of Material. The control owners may be, for example, firewalls, load balancers, routers, application firewalls, IAM policy controllers, DNS servers, and egress controls of the cloud computing server system. The control owners may provide security and availability guarantee for the service owners

The control configuration control planes 140 may be any suitable processes and services running on the server system 100 that may implement control planes for the various control owners of the server system 100. For example, the control configuration control planes 140 may include separate control configuration control planes for firewalls, load balancers, routers, application firewalls, IAM policy controllers, DNS servers, and egress controls of the server system 100, which may each be a separate control owner. The control configuration control planes 140 may be able to generate rules for the security components 150 from security policies provided by the control owner agents of the configuration realization control plane 130, and schedulers, workers, and provisioning agents for provisioning the generated rules to the security components 150.

The security components 150 may be the components, including any suitable hardware and software, of the server system 100, that may provide network security. The security components 150 may include, for example, hardware and software firewalls, routers, load balancers, IAM servers, DNS servers, and egress controls. The security components 150 may control both network traffic between components of and applications and services running on the server system 100 and any external networks and network traffic between the components, applications, and services, of the server system 100 within the server system 100. This security components 100 may, for example, enforce network segmentation, embargos, and identity and access management (IAM) policies.

The storage 160 may be any suitable combination of hardware and software for storing data. The storage 160 may include any suitable combination of volatile and non-volatile storage hardware, and may include components of the server system 100 and hardware accessible to the server system 100, for example, through wired and wireless direct or network connections. The storage 160 may store, for example, configuration bundles 161. Each service owner with an application or service on the server system 100 may have a configuration bundle in the configuration bundles 161 that reflects the current security policies that the service owner has defined for their applications and services. The configuration bundles 161 may be stored in an artifactory or repository within the storage 160.

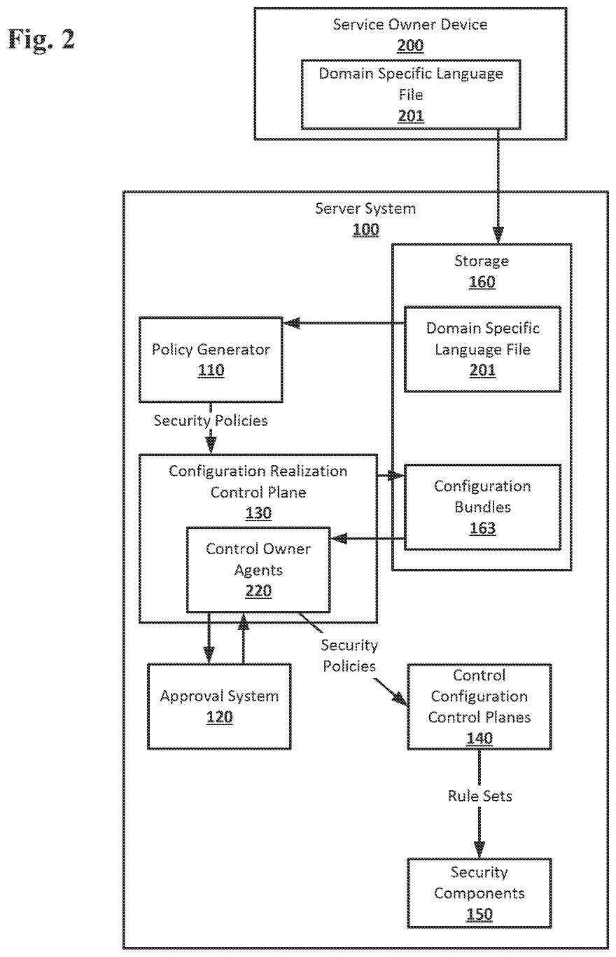

FIG. 2 shows an example arrangement suitable for network security policy generation and distribution according to an implementation of the disclosed subject matter. A service owner device 200 may be, for example, the computer 20 as described in FIG. 6, or components thereof. The service owner device 200 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The service owner device 200 may be part of a computing system and network infrastructure, or may be otherwise connected to the computing system and network infrastructure, including a larger server network which may include other server systems similar to the service owner device 200. The computing device 100 may include any suitable combination of central processing units (CPUs), graphical processing units (GPUs), and tensor processing units (TPUs).

The service owner may have an application or service on the server system 100. The service owner may use the service owner device 200 to generate domain specific language file 201. The domain specific language file 201 may include security policies written in a domain specific language. The security policies in the domain specific language file 161 may be security policies that the service owner wants to implement on the server system 100 for their applications and services on the server system 100. The domain specific language file 161 may include new security policies and changes to previously implemented security policies.

The service owner device 100 may send the domain specific language file 201 to the server system 100, for example, using an API of the server system 100. The policy generator 110 may generate a representation of the security policies that are specified using the DSL in the domain specific language file 201, such as cloud native enforcement artifacts 163. The representation of the security policies, as generated by the policy generator 110, may be sent to the configuration realization control plane 130, which may update the configuration bundle of the service owner of the service owner device 200 in the configuration bundles 163 with the representation of the security policies. This may result in the configuration bundle representing the service owner's desired security policies for their services and applications on the server system 100. The policy generator 110 may continuously generate representations of security policies from domain specific language files as they are continuously received from service owners. The configuration realization control plane 130 may continuously update configuration bundles in the configuration bundles 163 as representations of security policies are received from the policy generator 110.

The control owner agents 220 may continuously monitor the configuration bundles 163 for updates made by the configuration realization control plane 130. Each control owner agent of the control owner agents 220 may be associated with one of the control configuration control planes 140 and may monitor for updates that effect security policies that are implemented by the control owner configuration control plane associated with the control owner agent. The updates that effect a security policy may, for example, change current security policies, add new security policies, or remove old security policies. For example, a firewall control owner agent may continuously monitor the configuration bundles 163 for updates that effect security policies that are implemented by the firewall control plane. When a control owner agent detects an update effecting a security policy implemented by the control configuration control plane associated with the control owner agent, the control owner agent may check the approval system 120 to determine if the updated security policies are approved. The approval system 120 may, for example, check the updated security policies against the baseline security policies for the server system 100 as specified by the control owners and against security policies specified by other service owners on the server system 100.

If the security policy is approved, either through auto-approval or manual approval, the control owner agent may use an appropriate API to send the security policy to the appropriate one of the control configuration control planes 140. For example, the firewall control owner agent may send an updated security policy for the firewalls of the server system to the firewall control plane using an appropriate API. The security policies may be sent in, for example, the format of the representation generated by the policy generator 110. This may result in the merging of the security policies from the domain specific language file 201 into the security configuration for the server system 100. When a security policy is not approved by the approval system 120, the changes to the configuration bundle that was updated with the security policy may need to be rolled back so that the configuration bundle is in the same state it was before it was updated with the non-approved security policy. This may be done automatically or may be done by the service owner using the service owner device 200, for example, sending another domain specific language file with a security policy that undoes the non-approved security policy.

The control configuration control planes 140 may continuously receive security policies as they are sent by the control owner agents 220 of the configuration realization control plane 130. The control configuration control planes 140 may continuously generate rule sets from the received security policies as they are received and continuously distribute these rule sets to the security components 150. This may bring the configuration of the security components 150 of the server system 100 into agreement with the security configuration of the server system 100 as represented by the configuration bundles 161 and the baseline security policy, thereby implementing the security configuration on the server system 100. The rule sets generated by a control configuration control plane may ordered sets of rules in a format suitable for the security components, of the security components 150, the control configuration control plane is associated with. For example, a firewall control plane may receive security policies that are meant to be implemented by firewalls and may generate rule sets for the hardware and software components operate as the firewall of the server system 100, including, for example, both hardware firewalls and software firewalls.

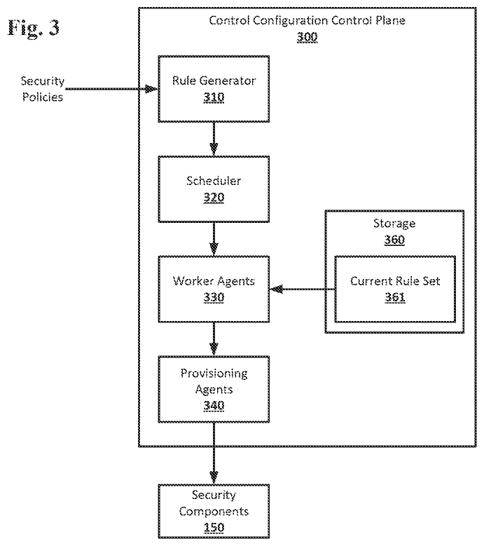

FIG. 3 shows an example arrangement suitable for network security policy generation and distribution according to an implementation of the disclosed subject matter. A control configuration control plane 300 may be one of the control configuration control planes 140. The control configuration control plane 300 may, for example, be a firewall control plane. A rule generator 310 may receive security policies from the control owner agent associated with the control configuration control plane 300 and convert the security policies into rule sets for the security components associated with the control configuration control plane 300. For example, the rule generator 310 may receive firewall security policies from a firewall agent of the configuration realization control plane 130 and may generate from the firewall security policies firewall rule sets for hardware and software firewalls of the server system 100. The rule sets generated by the rule generator 310 may be added to the scheduling queue of a scheduler 320.

The scheduler 320 may be a scheduling component of the control configuration control plane 300 that may pick rules from the scheduling queue and assign them to worker agents 330. The worker agents 330 may perform a diff operation with the rule set generated by the rule generator 310 and a current rule set 361 to identify what rules need to be added, removed or updated in order implement the rule sets assigned to them and ensure that the security policies of the server system 100 are brought up-to-date with the security configuration by implementing the rule sets from the queue assigned to the worker agents 330. The current rule set 361 may include all of the rules currently implemented on the security components associated with the control configuration control plane 300. The worker agents 330 may then pass the result of the diff operations, including what rules to add, remove, or update, to provisioning agents 340 of the control configuration control plane 300. After the diff operation is performed, the current rule set 361 may be updated to reflect the rule set generated by the rule generator 310.

The provisioning agents 340 may generate the configurations specific to the security components, including hardware and software components, of the security components 150, that will be used to enforce the rules, implementing the security policies in the security configuration. For example, if a hardware firewall of a specific type is used by the server system 100, a provisioning agent specific to that type of firewall may generate the configuration for the firewall to implement and rules that need to be enforced by that firewall. If there is no transactional support, the provisioning agent of the provisioning agents 340 may try to imitate a transactional logic on top of the exposed mechanism of the component that the provisioning agent is meant to configure. Provisioning agents may also use a retry logic with a backoff algorithm, so that a provisioning agent may retry configuring a component in the event of configuration failures a set of number of times before rolling back the component to its last good known configuration and sending a notification, for example, to a party responsible for maintain the component indicating that configuration failed. Each of the control configuration control planes 140 may have its own provisioning agents that may be specific to the different ones of the security components 150 of the server system 100 that each of the control configuration control planes 140 is responsible for configuring.

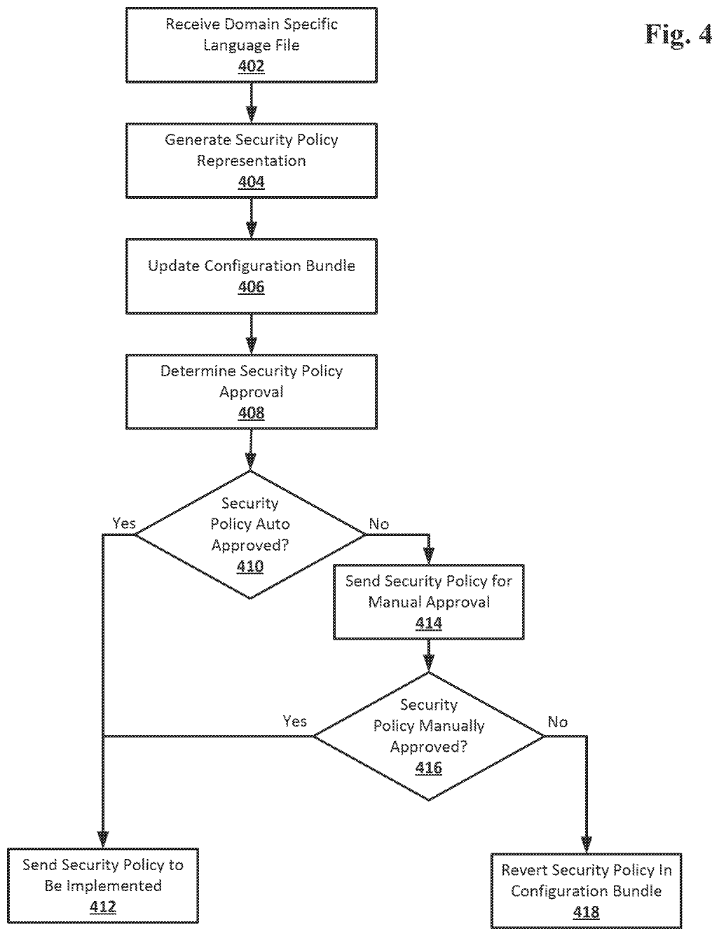

FIG. 4 shows an example procedure suitable for network security policy generation and distribution according to an implementation of the disclosed subject matter. At 402, a file with code written in a domain specific language may be received. For example, the server system 100 may receive the domain specific language file 16 from the service owner device 200. The domain specific language file 161 may include code written in a domain specific language that may be an intent based language used to define network security policies for applications and services that the service owner has running on the server system 100. The server system 100 may continuously receive domain specific language files from service owners as they are sent by the service owners.

At 404, a representations of a security policy may be generated. For example, example, the policy generator 110 may generate cloud native enforcement artifacts from the domain specific language file 161. The representations of any security policies specified in the domain specific language file 161 may be, for example, files that may include machine-readable and implementable code that may, for example, define which ports are open and closed, which protocols are in use on open ports, and which services exposed through open ports. The policy generator 110 may continuously generate representations of security policies as domain specific language files are received at the server system 100.

At 406, a configuration bundle may be updated. For example, a configuration bundle, from the configuration bundles 161, that corresponds to the service owner from whom the domain specific language file 161 was received may be updated with the representations of the security policies generated by the policy generator 110 from the domain specific language file 161. The configuration bundles 161 may already store all previously specified security policies from service owners with applications and services on the server system 100 and may be continuously updated with new security policies as they are generated by the policy generator 110.

At 408, whether a security policy is approved may be determined. For example, a control owner agent of the control owner agents 220 may detect that the configuration bundle has been updated with a security policy that is implemented by the control owner associated with that control owner agent. The security policy may be a change to an existing security policy or a new security policy. The control owner agent may check the security policy with the approval system 120 to determine if the security policy is auto-approved for implementation on the server system 100. The control owner agents 220 may continuously monitor the configuration bundles 161 for updated security policies and check the approval system 120 to determine if updated security policies are approved.

At 410, if the security policy is auto-approved, flow may proceed to 412. Otherwise, if the security policy is no auto-approved, flow may proceed to 414. For example, a number of security policies may be registered with the approval system 120 for auto-approval.

At 412, the security policy may be sent to be implemented. For example, the security policy may have been auto-approved by the approval system 120 or manually approved by a control owner. The control owner agent that checked the security policy with the approval system 120 may send the security policy to be implemented by control configuration control plane associated with the control owner agent. The control owner agent may, for example, invoke an API of the control configuration control plane to provide the security policy to the control configuration control plane or to indicate to the control configuration control plane a location on the server system 100 from which it can read the security policy. The security policy may be in the form of the representation generated by the policy generator 110. The security policy may remain in the configuration bundle that belongs to the service owner, being merged into the security configuration of the server system 100. The control owner agents 220 may continuously send approved security policies to the appropriate control configuration control planes 140.

At 414, the security policy may be sent for manual approval. For example, the approval system 120 may determine that a security policy being checked by a control owner agent is not eligible for auto-approval. The approval system 120 may send the security policy to be manually approved by the appropriate control owner. For example, the approval system 120 may send a security policy that is meant for implementation by the firewall to an appropriate party associated with the firewall, such as an appropriate network security engineer who may manually review and approve or disapprove the security policy.

At 416, if the security policy is manually approved, flow may proceed to 412. Otherwise, flow may proceed to 418.

At 418, the security policy may be reverted in the configuration bundle. For example, because the security policy was not approved, the security policy may need to be reverted so that it is no longer represented in the configuration bundle. Because the configuration bundle may be immutable, reverting the security policy that was not approved may require adding a new security policy to the configuration bundle that cancels out the security policy that was not approved. This may be done automatically, for example, by the appropriate control owner agent, or may require the service owner to provide the new security policy through a domain specific language file. The control owner agent may not send a non-approved security policy to be implemented by the associated control configuration control plane.

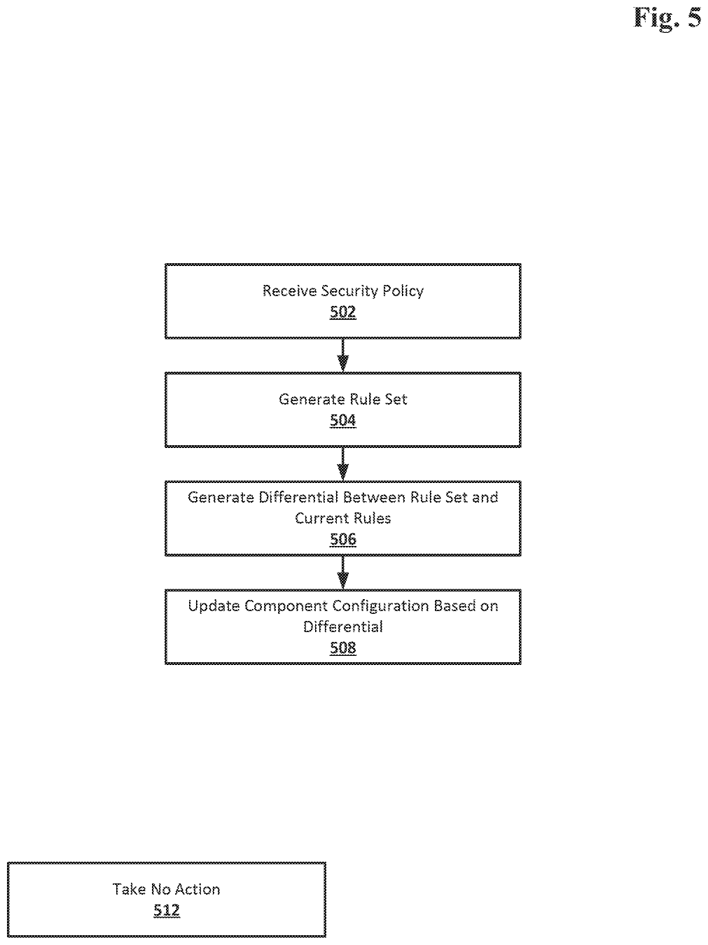

FIG. 5 shows an example procedure suitable for network security policy generation and distribution according to an implementation of the disclosed subject matter. At 502, a security policy may be received. For example, a representation of security policies may be received at the control configuration control plane 300 from its associated control owner agent in the configuration realization control plane 130. The received security policies may be received in any suitable format and manner. For example, the received security policies may be sent through an API of the control configuration control plane, or the control configuration control plane may receive the security policy by accessing them in a repository, for example, an artifactory that stores the configuration bundles 161. Each of the control configuration control planes 140 on the server system 100 may continuously receive security policies as they are provided by the control owner agents of the configuration realization control plane 130.

At 504, a rule set may be generated. For example, the rule generator 310 may generate a rule set from a security policy received at a control configuration control plane 300. The rule set may include rules that may be used to implement the security policy on the security components 150 that are associated with the control configuration control plane 300. For example, the rule set generated based on a security policy received at a firewall control plane from a firewall agent may include rules to implement the security policy on hardware and software firewall components of the server system 100. The rules in the rule set may be generated in a format that is specific to the hardware and software that the rules will be implemented on. Each rule generator, such as the rule generator 310, of the control configuration control planes 140 may continuously generate rule sets from received security policies.

At 506, a differential between the rule set and current rules may be generated. For example, the rule set generated by the rule generator 310 may be assigned to the scheduling queue of the scheduler 320, which may assign the rule set to one of the worker agents 330. The worker agent that is assigned the rule set may perform a diff operation to determine a differential that may indicate the differences between the rule set and the current rule set 361. This differential may indicate what rules need to be added, updated, or removed, on the security components associated with the control configuration control plane 300 to implement the security policy that was received from the control owner agent. Worker agents, such as the worker agents 330, of the control configuration control planes 140 may continuously perform diff operations to generate differentials between rule sets generated rule generators such as the rule generator 310 and current rule sets.

At 508, component configurations may be updated based on the differential. For example, a differential generated by one of the worker agents 330 may be passed on by that worker agent to one of the provisioning agents 340 of the control configuration control plane 300. The provisioning agent may update the configurations of the appropriate security components to implement the added, changed, and updated rules as determined from the differential, thereby implementing the security policy that was received at the control configuration control plane 300. This may bring the configuration of the security components 150 up-to-date with the security configuration of the server system 100 as represented by the configuration bundles 161 and the baseline security policy. Provisioning agents, such as the provisioning agents 340, of the control configuration control planes 140 may continuously update the security components 150 based on differentials as the differentials are generated by worker agents such as the worker agents 330, allowing for continuously distribution of security policies to the security components 150 of the server system 100.

Implementations of the presently disclosed subject matter may be implemented in and used with a variety of component and network architectures. FIG. 6 is an example computer 20 suitable for implementing implementations of the presently disclosed subject matter. As discussed in further detail herein, the computer 20 may be a single computer in a network of multiple computers. As shown in FIG. 6, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 7.

Many other devices or components (not shown) may be connected in a similar manner (e.g., document scanners, digital cameras and so on). Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

FIG. 7 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving, at a computing device, a security policy written using a Domain Specific Language (DSL) for network security, the security policy associated with a service owner and a control plane;
generating, by the computing device, from the security policy, a representation of the security policy;
updating, by the computing device, a configuration bundle of the service owner with the representation of the security policy;
determining, by the computing device, that the security policy is approved;
generating, by the computing device, a rule set from the representation of the security policy;
determining, by the computing device, a differential between the rule set and a current rule set; and
configuring, by the computing device, a security component associated with the control plane based on the differential.

2. The computer-implemented method of claim 1, wherein the computing device comprises a configuration realization control plane, and wherein control owner agents run in the configuration realization control plane, and further comprising:
monitoring, by the control owner agents, the configuration bundles to detect changes to the configuration bundles.

3. The computer-implemented method of claim 1, wherein the computing device further comprises control configuration control planes which are associated with control owners and security components of the computing device, wherein the security components include the security component.

4. The computer-implemented method of claim 3, wherein the control configuration control planes further comprise provisioning agents, and wherein configuring, by the computing device, a security component associated with the control plane based on the differential is performed by one of the provisioning agents.

5. The computer-implemented method of claim 3, wherein the control configuration control planes further comprise worker agents, and wherein determining, by the computing device, a differential between the rule set and a current rule set is performed by one of the worker agents.

6. The computer-implemented method of claim 1, further comprising:
receiving, at the computing device, a second security policy written using the Domain Specific Language (DSL) for network security, the second security policy associated with the service owner and the control plane;
generating, by the computing device, from the second security policy, a representation of the second security policy;
updating, by the computing device, the configuration bundle of the service owner with the representation of the second security policy; and
determining, by the computing device, that the second security policy is not approved;
reverting the updating of the configuration bundle with the representation of the second security policy.

7. The computer-implemented method of claim 1, wherein the security component comprises a firewall, a load balancer, a router, an application firewall, an IAM policy controller, a DNS server, or an egress control.

8. A computer-implemented system comprising:
a storage; and
one or more processors that receive a security policy written using a Domain Specific Language (DSL) for network security, the security policy associated with a service owner and a control plane,
generate from the security policy, a representation of the security policy,
update a configuration bundle of the service owner with the representation of the security policy,
determine that the security policy is approved,
generate a rule set from the representation of the security policy,
determine a differential between the rule set and a current rule set,
configure a security component associated with the control plane based on the differential.

9. The computer-implemented system of claim 8, wherein a configuration realization control plane is implemented on the one or more processors, and wherein control owner agents run in the configuration realization control plane, and wherein the one or more processors further monitor, with the control owner agents, the configuration bundles to detect changes to the configuration bundles.

10. The computer-implemented system of claim 8, wherein control configuration control planes are implemented on the one or more processors and are associated with control owners and security components of the system, wherein the security components include the security component.

11. The computer-implemented system of claim 10, wherein the control configuration control planes further comprise provisioning agents, and wherein the one or more processors use one of the provisioning agents to configure the security component associated with the control plane based on the differential.

12. The computer-implemented system of claim 10, wherein the control configuration control planes further comprise worker agents, and wherein the one or more processors use the worker agents to determine the differential between the rule set and the current rule set.

13. The computer-implemented system of claim 10, wherein the one or more processors further:
receive a second security policy written using the Domain Specific Language (DSL) for network security, the second security policy associated with the service owner and the control plane,
generate, from the second security policy, a representation of the second security policy;
update the configuration bundle of the service owner with the representation of the second security policy,
determine that the second security policy is not approved, and
revert the update of the configuration bundle with the representation of the second security policy.

14. The computer-implemented system of claim 8, wherein the security component comprises a firewall, a load balancer, a router, an application firewall, an IAM policy controller, a DNS server, or an egress control.

15. A system comprising: one or more computers and one or more non-transitory storage devices storing instructions which are operable, when executed by the one or more computers, to cause the one or more computers to perform operations comprising:
receiving, at a computing device, a security policy written using a Domain Specific Language (DSL) for network security, the security policy associated with a service owner and a control plane;
generating, by the computing device, from the security policy, a representation of the security policy;
updating, by the computing device, a configuration bundle of the service owner with the representation of the security policy;
determining, by the computing device, that the security policy is approved;
generating, by the computing device, a rule set from the representation of the security policy;
determining, by the computing device, a differential between the rule set and a current rule set; and
configuring, by the computing device, a security component associated with the control plane based on the differential.

16. The system of claim 15, wherein the computing device comprises a configuration realization control plane, and wherein control owner agents run in the configuration realization control plane, and wherein the instructions are further operable, when executed by the one or more computers, to cause the one or more computers to further perform operations comprising:
monitoring, by the control owner agents, the configuration bundles to detect changes to the configuration bundles.

17. The system of claim 16, wherein the computing device further comprises control configuration control planes which are associated with control owners and security components of the computing device, wherein the security components include the security component.

18. The system of claim 17, wherein the control configuration control planes further comprise provisioning agents, and wherein configuring, by the computing device, a security component associated with the control plane based on the differential is performed by one of the provisioning agents.

19. The system of claim 17, wherein the control configuration control planes further comprise worker agents, and wherein determining, by the computing device, a differential between the rule set and a current rule set is performed by one of the worker agents.

20. The system of claim 15, wherein the instructions are further operable, when executed by the one or more computers, to cause the one or more computers to further perform operations comprising:
receiving, at the computing device, a second security policy written using the Domain Specific Language (DSL) for network security, the second security policy associated with the service owner and the control plane;
generating, by the computing device, from the second security policy, a representation of the second security policy;
updating, by the computing device, the configuration bundle of the service owner with the representation of the second security policy; and
determining, by the computing device, that the second security policy is not approved;
reverting the updating of the configuration bundle with the representation of the second security policy.
